(19) United States
(12) Patent Application Publication
(10) Pub. No.: US 2015/0315827 A1
(43) Pub. Date: Nov. 5, 2015

(54) METHOD FOR PRODUCING MOTOR VEHICLE LOCKS WITH LATCH SURFACES ASSOCIATED WITH A PUZZLE PART

(71) Applicant: KIEKERT AKTIENGESELLSCHAFT, Heiligenhaus (DE)

(72) Inventors: Thorsten BENDEL, Oberhausen, North Rhine-Westphalia (DE); Werner POHLE, Dortmund, North Rhine-Westphalia (DE); Thomas WALDMANN, Mulheim Ruhr, North Rhine-Westphalia (DE)

(21) Appl. No.: 14/649,935

(22) PCT Filed: Dec. 11, 2013
(86) PCT No.: PCT/DE2013/000771

§ 371 Date: Jun. 5, 2015

(30) Foreign Application Priority Data
Dec. 12, 2012 (DE) 10 2012 024 303.0

(51) Int. Cl. E05B 85/24; E05B 79/10; B21D 53/88; B21D 22/02; B21D 53/28

(52) U.S. Cl. CPC E05B 85/243; B21D 22/02; B21D 53/28; B21D 53/88; E05B 79/10

(57) ABSTRACT

In order to minimize the sliding friction appearing between the pawl and the rotary latch of a motor vehicle door lock, it is advantageous, if during the production process, the various catch surfaces of both locking parts are associated with one or also two puzzle components, said puzzle components being inserted into the main latch area of the pawl or rotary latch, in a secured position in correspondingly adapted puzzle-shaped contours. Said edge surfaces can advantageously compensate the effect of the adverse stamped contours present on the other locking part such that both locking parts are in mutual contact reducing the friction.

### CROSS-REFERENCE TO RELATED APPLICATIONS

This application is the U.S. national stage application of International Patent Application No. PCT/DE2013/000771, filed Dec. 11, 2013, which claims priority of German Application No. 10 2012 024 303.0, filed Dec. 12, 2012, which are both hereby incorporated by reference.

### BACKGROUND

The invention refers to a method for producing the locking mechanism parts catch and pawl of a motor vehicle door latch, in which the catch and pawl are stamped to provide vertical or near vertical edges with corresponding ratchet surfaces on both locking mechanism parts and are then covered by a coating with the exception of the ratchet surfaces. The invention also relates to a motor vehicle door latch with a catch and a pawl retaining the catch in its closed state, in which the catch and pawl contain corresponding ratchet surfaces on the vertical edges, created during stamping, as well as a coating that is, however, not applied to the ratchet surfaces.

It is known that creaking noises generated during driving of the motor vehicle and which can occur between the hanger arm and catch, can be reduced by either the hanger arm or also the catch being provided with a surface structure in the contact area, contributing to reducing the gliding friction. In the prior art disclosed in DE 10 2010 009 141 A1, grooves or respective webs are applied to the hanger arm in the contact area that run obliquely to the longitudinal axis of the hanger arm. These aim to reduce said creaking. In addition, the area of the seat of the catch contains inserts in the contact area between hanger arm and catch, whose aim is to support the effect of the hanger arm containing the surface structure or which can even take over its function. The surface of these inserts also contains a surface structure or is only plain. These inserts are relatively small and only remain in the intended position due to an indentation. Also, the described grooves and other surface structures are artificially generated and do not take into consideration the circumstances occurring during stamping of the catch and pawl.

### SUMMARY

The invention therefore has the task of simplifying the production of low-noise motor vehicle door latches or making such a production as effective as possible.

The method of the invention solves this task by stamping out contours for puzzle components during stamping of the locking mechanism parts in the area of the corresponding ratchet surfaces into which the puzzle components, having an edge surface that glides easily/is low in friction and/or is low in noise when catch and pawl come into contact, is securely inserted.

The use of separate puzzle components offers the option of either assigning a latching surface to the puzzle component that prevents noises from being generated when the catch and pawl slide past each other and containing, for instance, oblique grooves or providing smoothed edge surfaces. The advantage is thus the multitude of options available for the design of the puzzle surface or of the surface coming into contact with the adjacent locking mechanism part, so that depending on the cost situation or the desired result, different noise-reducing solutions can be implemented. Due to their design and corresponding puzzle-shaped contours, the individual puzzle components can be effectively secured to the locking mechanism parts after stamping of said parts, so that they can carry out their required tasks even after a longer operation of a motor vehicle door latch.

According to a further advantageous embodiment, the contours for the puzzle components are produced in the main latch area of the catch. This arrangement allows the size of the puzzle component to be adapted to the arrangement of the main latch area, so that the size of the puzzle components is also adapted to the conditions of the main latch area. It can be assumed that puzzle components and the contours have to be of a certain size to facilitate installation and to ensure the correct seat of the puzzle components in the contours.

The versatility of the used puzzle components allows for one puzzle component to be shaped to accommodate the ratchet surface of a locking mechanism part or for several puzzle components to accommodate the ratchet surfaces of both locking mechanism parts. In particular this allows to always provide a sufficiently large ratchet surface so that the desired contact surface can secure the precise and smooth operation of the motor vehicle door latch. It is, for instance, feasible that the puzzle component of the catch contains a larger ratchet surface than the puzzle component of the pawl.

Generally it is advantageous for production, when the surface of the puzzle component of the catch or of the pawl is produced to compensate for the stamping contours with grooves produced during stamping of the other locking mechanism part and preferably contains oblique grooves or stamped grooves. The compulsory straight grooves generated during stamping are thus assigned to the locking mechanism part, not subjected to any further machining, whilst the puzzle component of the other locking mechanism part is then equipped with a ratchet surface containing for instance oblique grooves so that both locking mechanism parts can advantageously cooperate and also generate less noise. The different grooves provided on the two locking mechanism parts cannot engage with each other, are only in contact at a few overlapping points and allow the two locking mechanism parts to glide past each other at low noise.

Apart from the option of using puzzle components with straight and oblique grooves, the invention also provides for a material to be used for the puzzle component, which is set to compensate for the effect of the surface structure of the other locking mechanism part generated during stamping and preferably that of the straight grooves. In this arrangement the second locking mechanism part does thus not contain a ratchet surface with oblique grooves but a ratchet surface which, as a result of the selected material, has the task of cooperating with the straight grooves of the other locking mechanism part at a reduced noise level.

In addition to a selection of material, the invention also allows the ratchet surface of the puzzle component of the catch or of the pawl to be hardened or coated. In this case, too, it makes sense to only harden or coat one ratchet surface of the locking mechanism parts, whilst the other part with the existing stamped grooves can be continued to be used. As the puzzle component is a separate component, special treatment in form of hardening or coating is not expensive.

The method of the invention solves the task by separately useable puzzle components being assigned to the ratchet surfaces or at least one ratchet surface, the stamped puzzle-shaped contours stamped during stamping of the locking mechanism parts being securely insertable and their edge surface/ratchet surface gliding easily and/or generating little noise when the ratchet surfaces of both locking mechanism parts slide past each other.

This special design of the catch and/or of the pawl as well as of the two locking mechanism parts of the motor vehicle door latch offers the option to form the puzzle components prior to their use in such a way that they can effectively provide the low-noise part when the locking mechanism parts glide along each other. Furthermore it is advantageous that the puzzle-shaped contours and the respective puzzle components allow a secure positioning in the respective locking mechanism part and that due to the precise shape not even a separate fixing is required. It is advantageous that not the entire puzzle component requires a certain low-noise design but that it suffices if the edge surface or the ratchet surface of the puzzle part has a low-friction finish or the ratchet surface is used, rendering the effect of the disadvantageous stamped grooves during moving of the two locking mechanism parts past each other ineffective. Preferably, the puzzle-shaped contours and the puzzle components are formed or arranged in the main latch area of the catch or of the pawl. This shows again that the actual goal of the present invention is to provide a design for the main latch area of the catch and for the pawl that enhances the operation, i.e. reduces the noise, which is achieved by the puzzle-shaped contours and the puzzle components preferably compensating for the effect of the respective other puzzle components.

In a particularly advantageous embodiment in which the ratchet surface on the puzzle component contains a contour with oblique grooves, the ratchet surface contains a stamping contour with straight/vertical grooves on the other locking mechanism part or contains groves that are reversed. This is advantageous as one of the two locking mechanism parts does, in this case, not require a puzzle component and can still be equipped and operated with the existing stamping grooves or stamping contours, whilst the second locking mechanism part alone and, preferably the catch, can with little effort as a result of oblique grooves on its ratchet surface, ensure that the previously experienced disadvantageous noises are reduced or can no longer occur. The straight grooves of the stamping contour are acted upon by the oblique grooves of the puzzle components or of the associated ratchet surfaces during movement of the pawl in such a way that contact is only made at the overlapping points, so that the straight stamping contours on the two locking mechanism parts do no longer engage with each other as before. At least two points of overlap per groove produce an even movement of the pawl past the catch so that also a smooth movement is guaranteed.

Instead of a special groove formation on the respective puzzle component, a further development of the invention offers the option of producing the puzzle component from a material, compensating for the effect of the stamping contour on the other locking mechanism part or rendering it ineffective or containing a hardened or coated surface. The hardened or coated surface naturally also compensates for the effect of the stamping contour for the non-straight grooves, so that during hardening and coating only the respective ratchet surface has to be designed in this way, whilst according to the other solution, the entire puzzle component is made from a respective high-friction material.

The particular advantage of the invention is that it provides a motor vehicle door latch with relatively little additional manufacturing effort, in which the pawl and catch in the latching area, i.e. in the area in which they both rest against or on top of each other, are designed in such a way that noises generated in prior art embodiments are clearly reduced. Also, a uniform movement of the pawl along the catch is ensured, as the special form of the ratchet surface of preferably one of the locking mechanism parts, facilitates movement, as this separately formed ratchet surface is assigned to a puzzle component that can be easily and securely inserted into a puzzle-shaped contour of one of the locking mechanism parts. The straight stamped groves remaining on the other locking mechanism part or the respective stamping contour is in this case compensated for by the respectively formed ratchet surface on the puzzle component in such a way that the previously experienced unwanted noises can no longer occur or have been considerably reduced. Naturally there is also the option to assign a respective puzzle component to both locking mechanism parts and to provide it with a particularly suitable ratchet surface, so that all noises are cancelled out.

Further details and advantages of the object of the invention are disclosed in the below description of the associated drawing in which a preferred embodiment with the respective details and parts is shown. In which:

### BRIEF DESCRIPTION OF THE DRAWINGS

FIG. 1 shows a top view of a motor vehicle door latch in its closed state,

FIG. 2 shows the catch and pawl of FIG. 1 with puzzle components in the main latch area,

FIG. 3 shows a puzzle component with artificial grooves,

FIG. 4 shows a puzzle component with a ratchet surface containing a coating,

FIG. 5 shows a puzzle-shaped contour in the main latch area of the pawl,

FIG. 6 shows an enlarged view of puzzle components in the main latch area of the catch and

FIG. 7 shows a perspective view of the catch with a special edge formation.

### DETAILED DESCRIPTION OF THE DRAWINGS

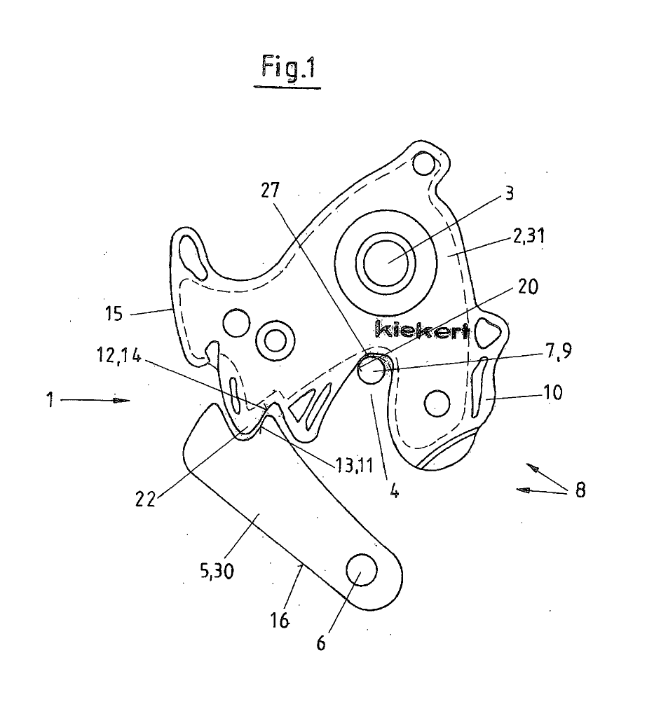

FIG. 1 shows a top view of a motor vehicle door latch 1, in which the catch 2 moving around axis 3 securely clasps the hanger arm 9 of the lock bracket 7. The figure thus shows the closed state of a motor vehicle door latch 1, with the catch 2 being secured by the pawl 5 pivotable around pawl axis 6, i.e. the motor vehicle door latch 1 can only be opened again once the pawl 5 has been pivoted away which is achieved by means of the motor vehicle door handle, not shown in the figure. By means of the seat 4, the hanger arm 9 is moved into the lowest point 27 of the catch 2, thus securing the closed state, also of the motor vehicle door—not shown—with the locking mechanism parts 30, 31, i.e. the pawl 5 and the catch 2 being parts of the motor vehicle door, whilst the lock bracket 7 and the hanger arm 9 are fixed to the car body of the motor vehicle. The locking mechanism parts 30, 31 of the locking mechanism 8 are produced from respective sheet metal using a, preferable, multiple stamping operation, in which on the ratchet surfaces 12, 13 not covered by coating 10, the surface of both locking mechanism parts 30, 31 is characterized by a stamped contour 14. In the area of the ratchet surface 13, this surface arrangement has, however, been changed by the ratchet surface 13 being assigned to a separate component, which is explained in more detail below. The stamping contour 11 on the locking mechanism part 30 thus differs from the stamping contour 11 on the locking mechanism part 31. The respective grooves 18, 19 are arranged in an oblique manner and the grooves 17, i.e. the straight stamped grooves, ensure a much improved sliding friction between the locking mechanism parts 30, 31 that is to say the pawl 5 and the catch 2, so that unwanted noises are no longer produced. Not particularly apparent from the figure is the fact that the edges 15, 16 of the catch 2 and the pawl 5 are covered by a plastic coating 10. The edges 15, 16 are thus covered by such a coating with the exception of the area of the ratchet surfaces 12, 13 and of the contact surface 20 where no coating 10 is applied, allowing the special surface structure shown in the below figures, to become effective. The surface structure reduces noise and sliding friction to a minimum, with both being related. The ratchet surfaces 12, 13 lie in the area of the main catch 22. Their arrangement is shown in the below figures.

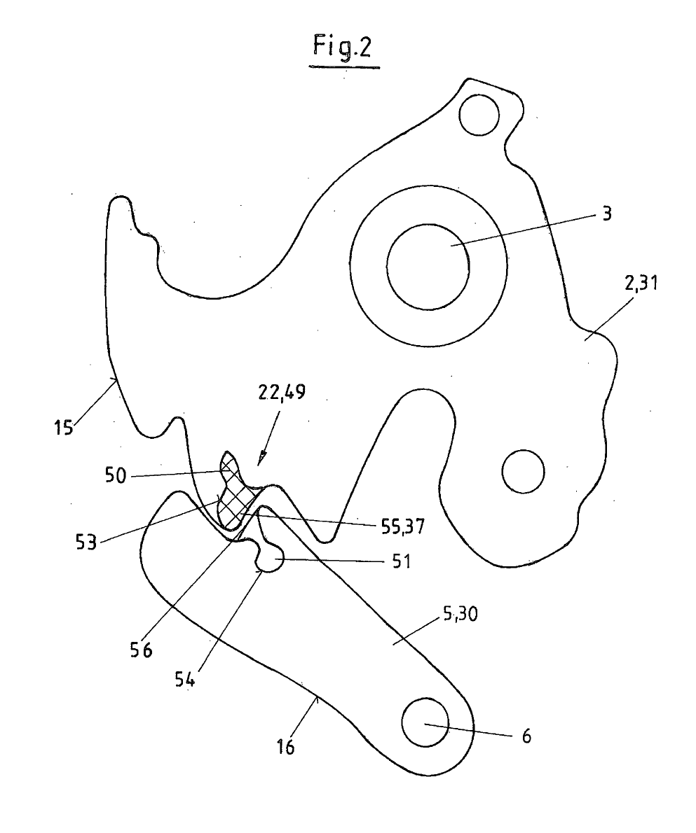

FIG. 2 first of all shows that puzzle-shaped contours 53, 54 are provided in the main catch 22 in the catch 2 and in the pawl 5, in which adjusted puzzle components 50, 51 are securely inserted. These puzzle components 50, 51 contain the specially formed ratchet surfaces 12, 13 on their edge surfaces 55, 56 as shown in the below figures. The respectively formed edge surface 55 is provided on the facing area 37 of the puzzle component 50 with FIG. 2 showing a solution in which two puzzle components 50, 51 are assigned to the catch 2 or the pawl 5. Generally, the puzzle component 50 and the edge surface 55 will suffice, for which in this case the puzzle-shaped contour 53 is produced in the catch 2 beforehand during stamping.

FIG. 3 shows a puzzle component 50 whose edge surface 55 contains oblique grooves 18, 19. These cooperate without friction when catch 2 and pawl 5 pass each other, as the ratchet surface 13 of the pawl 5 with the straight grooves 17 only has few points of overlap 25, 25′ with the oblique grooves 18, 19 of the edge surface 55, when the two locking mechanism parts 30, 31 pass each other as described. Instead of the groove formation, FIG. 4 shows an edge surface 55 or also 56 of a puzzle component 50, 51 onto which a hard coating has been applied or a smooth surface ensures that the grooves 17 or 18, 19 on the locking mechanism part 30 or 31 are rendered ineffective in the main latch area 49.

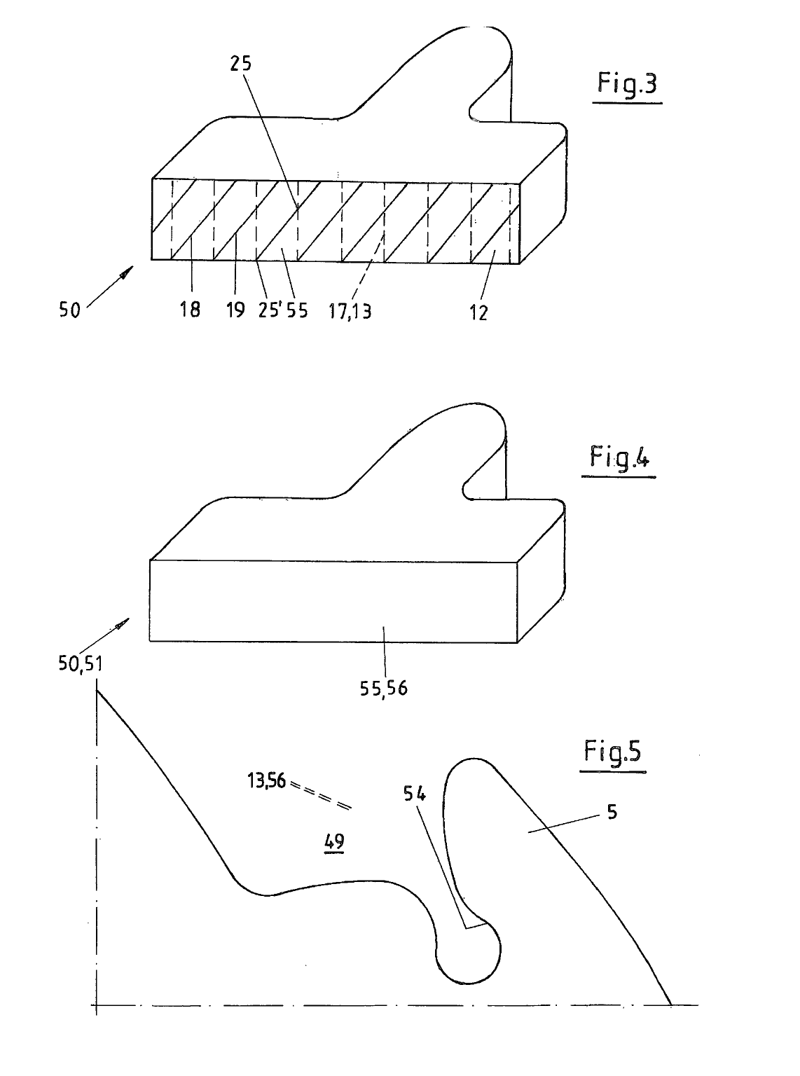

FIG. 5 shows a puzzle-shaped contour 54 in the main latch area 49, i.e. in the pawl 5. In this puzzle-shaped contour 54, the puzzle component 51 shown in FIG. 2 is securely inserted with, in order to achieve the intended result, only this puzzle component 51 containing an edge surface 56, as shown for the other locking mechanism part 31 in FIG. 3 and FIG. 4.

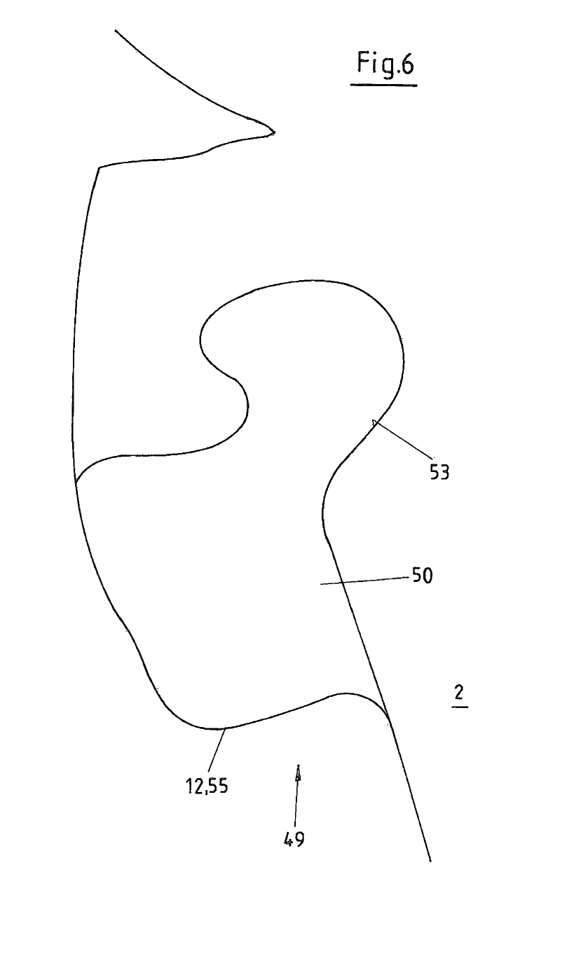

Whilst FIG. 5 of the main latch area 49 shows the pawl 5, FIG. 6 shows the main latch area 49 of the catch 2. It is apparent that, here too, a puzzle-shaped contour 53 was produced during stamping of the puzzle-shaped catch 2 into which the puzzle component 50 is inserted or slid into. The edge surface 55 than has a finish as described in FIG. 3 or 4 or as explained in the description.

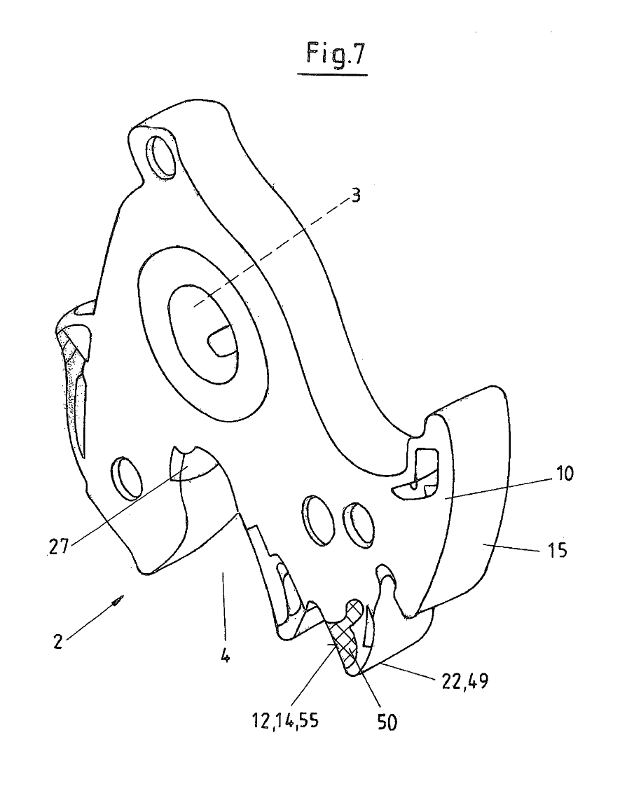

FIG. 7 shows a perspective view of catch 2, pivotable around axis 3—not shown. During pivoting of this catch 2, the hanger arm 9, not shown in FIG. 7 is inserted in the seat 4 and subsequently released again, so that the motor vehicle door can then be opened or closes evenly. In the locked position, the catch 2 is retained by the pawl 5. FIG. 7 shows that the stamping of the catch 2 produces a clearly visible edge 5, whose surface, as explained above, is characterized by the stamped contour 14, in particular on the ratchet surface 12. This stamped contour 14 is only indicated in FIG. 7. The ratchet surface 12 indicates the main ratchet position 22, i.e. the position in which the pawl 5 prevents the catch 2 from pivoting back when in the closed position. As already mentioned above, the ratchet surface 13 of the pawl then rests on the ratchet surface 12 of the catch 2 and both can slide past each other with less friction and without any unwanted noise being generated, as the straight grooves 17 of the catch 2 and the oblique grooves 18′, 19′ of the pawl 5 cannot engage or interlock. The straight grooves can, however, also be assigned to the pawl and the oblique grooves 18, 19 to the catch.

A puzzle component 50 is shown in the area of the main catch 22, 49, whose edge surface 55 corresponds, for example, to the ratchet surface 12 with straight grooves 17. This edge surface 55 should correspond with the edge surface 56 of the pawl 5 in such a way that the existing grooves 17, 18, 19 do not engage or interlock.

At the lowest point 27 of the seat 4 it is apparent that it contains a surface differing from the other surface of the edge 15, which is achieved, in particular by the fact that it is not covered by a coating 10. The figure shows that a separate part has also been inserted in order to positively influence the gliding action of the catch 2 on the hanger arm 9.

All aforementioned characteristics, including those only shown in the drawings, are separately or in combination essential parts of the invention.

1. Method for producing the locking mechanism parts catch and pawl of a motor vehicle door latch, in which the catch and pawl are stamped, resulting in vertical or near vertical edges with corresponding ratchet surfaces for both locking mechanism parts which are then covered by a coating except for the latching surfaces, characterized in that contours for puzzle components are stamped during stamping of the locking mechanism parts in the area of the corresponding ratchet surfaces, into which puzzle components, having an edge surface that glides easily/is low in friction and/or is low in noise when catch and pawl come into contact with each other, are securely inserted.

2. Method according to claim 1, characterized in that the contours for the puzzle components are produced in the main latch area of the catch.

3. Method according to claim 1, characterized in that a puzzle component containing the ratchet surface of a locking mechanism part or several puzzle components containing the ratchet surfaces of both locking mechanism parts are formed.

4. Method according to claim 1, characterized in that the surface of the puzzle component of the catch or of the pawl is produced to compensate for the stamped contour with grooves produced during stamping of the other locking mechanism part and then preferably contains oblique grooves or stamped grooves.

5. Method according to claim 1, characterized in that a material is used for the puzzle component that is set to compensate for the effect of the surface structure of the other locking mechanism part and preferably that of the straight grooves.

6. Method according to claim 5, characterized in that the ratchet surface of the puzzle component of the catch or of the pawl is hardened or coated.

7. Motor vehicle door latch containing a catch and a pawl retaining the catch in the closed state, in which the catch and pawl contain corresponding ratchet surfaces on their vertical edges, produced during stamping, as well as a coating except for on the ratchet surfaces, characterized in that the ratchet surfaces or at least one ratchet surface are assigned to separately useable puzzle components, which are securely inserted into puzzle-shaped contours stamped during stamping of the locking mechanism parts and whose edge surface/ratchet surface is designed to glide easily and/or generate little noise when the ratchet surfaces of both locking mechanism parts come into contact.

8. Motor vehicle door latch according to claim 7, characterized in that the puzzle-shaped contours and the puzzle components are formed or arranged in the main latch area of the catch or of the pawl.

9. Motor vehicle door latch according to claim 7, characterized in that the ratchet surface on the puzzle component has a contour containing oblique grooves and the ratchet surface on the other locking mechanism part has a stamped contour containing straight/vertical grooves or in which the groove arrangement is the other way around.

10. Motor vehicle door latch according to claim 7, characterized in that the puzzle component is made from a material, compensating for the effect of the stamping contour on the other locking mechanism part or making it ineffective or containing a hardened or coated surface.

11. Motor vehicle door latch according to claim 8, characterized in that the puzzle component is made from a material, compensating for the effect of the stamping contour on the other locking mechanism part or making it ineffective or containing a hardened or coated surface.

12. Motor vehicle door latch according to claim 9, characterized in that the puzzle component is made from a material, compensating for the effect of the stamping contour on the other locking mechanism part or making it ineffective or containing a hardened or coated surface.
